(19) United States
(12) Patent Application Publication
(10) Pub. No.: US 2018/0012250 A1
(43) Pub. Date: Jan. 11, 2018

(54) METHOD AND SYSTEM FOR RENDERING AND OPTIMIZING INTERNET CONTENT

(71) Applicant: Red Spark, LP (d/b/a Tiller, LP), Philadelphia, PA (US)

(72) Inventors: Gabriel Malca, Cote-Saint-Luc (CA); Steven Berlan, Conshohocken, PA (US)

(21) Appl. No.: 15/644,351

(22) Filed: Jul. 7, 2017

Related U.S. Application Data
(60) Provisional application No. 62/360,163, filed on Jul. 8, 2016.

(51) Int. Cl. G06Q 30/02; G06F 17/21

(52) U.S. Cl. CPC G06Q 30/0244; G06Q 30/0277; G06F 17/212; G06F 17/218

(57) ABSTRACT

Methods, systems, and apparatuses are described herein for managing an optimizing advertising content placement, rendering third party advertising tags, and tracking analytics associated with third party advertising content. The tag management system is a publisher-side platform for native and recommended content that enables publishers to manage their relationships with native advertising partners and optimize their placement of native ads. The global ad tag may detect a location within a HyperText Markup Language (HTML) document, wherein the location is associated with placement of advertising content. A script associated with the advertising content may then be loaded at that location on the HTML document. Analytics associated with the advertising content may then be tracked, and the analytics associated with the advertising content may be reported to a server running the tag management system.

### CROSS REFERENCE TO RELATED APPLICATIONS

This application claims the benefit of U.S. Provisional Application Ser. No. 62/360,163 filed Jul. 8, 2016, which is incorporated by reference as if fully set forth.

### FIELD OF THE INVENTION

The present application is generally related to internet advertising technology and more particularly related to a method and apparatus for managing and optimizing advertising content placement on a webpage, rendering third party advertising tags and other code, and tracking data associated with third party advertising content.

### BACKGROUND

Advertising technology has developed and changed significantly in the internet age, as the world wide web presents vast opportunities for advertisers, publishers, and advertising networks. Advertisers are constantly seeking to differentiate themselves and, in the process, find new and creative placements to present advertising offers to consumers. Similarly, internet publishers who own or operate internet properties in the form of websites are constantly seeking to monetize those websites by displaying various types of advertisements from a variety of partnerships.

Currently, various technologies and techniques exist in the internet advertising and marketing industry to connect advertisers with end users. The entity that provides or is represented in the advertising content is often referred to as the “advertiser,” while the entity that delivers such advertising content to the end user or consumer is often referred to as the “publisher.” In one example, the publisher may be an online website owner or operator, who incorporates advertising content into the website content in order to monetize the website. The increase of native and recommended content advertising has required publishers and their websites to utilize and be compatible with multiple native advertising platforms and systems.

Native advertising can be broadly described as advertising content that mimics the look and feel of the “native” content present on a publisher's website, which may be less visually disruptive to the user or viewer of the websites and therefore more likely to result in user engagement, and can be for example an advertisement linking to an article to a third-party publisher's website. Similarly, recommended content advertising often presents various articles or other content from third-party publishers' websites in a “widget” placed on a publisher's website. When a user of that publisher's website clicks on one of those advertisements presented through the recommended content widget and is directed to a third-party website that the ad links to, the publisher who is monetizing its site with the recommended content widget is compensated by the recommended content network. A publisher seeking to monetize its internet properties may work with a variety of different native and recommended content advertising networks, along with other types of advertisers to display other ad formats such as traditional display advertisements, video advertisements, or pop up advertisements. In order to properly implement each type of advertising format on the webpage, and to optimize the display of advertisements on different webpages and to different users, publishers need to incorporate the advertising code (i.e., advertising tags) from each advertising provider into the code of the individual publisher websites, and manually switch out the code in order to change the types of advertisements being displayed to users. This process is labor intensive, usually requiring a great deal of developer time and effort, and does not allow publishers to easily optimize the use of various advertising providers on their internet properties.

As the use of various types of online advertising continues to increase on the internet, a need exists to enable publishers to manage ad placement, track analytics associated with the displayed ads across different users and devices, and optimize selection of the specific advertising content that is incorporated into the publisher's website content.

### SUMMARY

Methods, systems, and apparatuses are described herein for managing and optimizing advertising content placement on a webpage, rendering third party advertising tags, and tracking data associated with third party advertising content.

Methods, systems, and apparatuses are described herein for managing and optimizing advertising content placement on a webpage, rendering third party advertising tags, and tracking analytics associated with third party advertising content. The tag management system is a publisher-side platform for various types of advertising formats, including native and recommended content ads, which enables publishers to easily manage their utilization of different advertising partners and optimize the placement of those ads. The tag management system may include a dashboard that provides a content management system for a publisher, allowing the publisher to manage the ad selection and placement process without the need for manually coding or switching out code associated with the specific ads being selected and displayed on a webpage. The tag management system may further include a “global tag” that is provided to the publisher and configured to operate in conjunction and be compatible with various advertising networks' own ad code or ad tags. The global ad tag may detect a location within a HyperText Markup Language (HTML) document, wherein the location is associated with placement of advertising content. A script associated with the advertising content may then be selected by the tag management system based on rules set up by the publisher through the dashboard or based on other criteria, and loaded at that location on the HTML document to display the desired advertising content. Analytics associated with the advertising content may then be tracked, and the analytics associated with the advertising content may be reported to a server running the tag management system, and utilize to further optimize the placement of advertising content on the publisher's internet properties.

### BRIEF DESCRIPTION OF THE DRAWINGS

A more detailed understanding may be had from the following description, given by way of example in conjunction with the accompanying drawings wherein:

FIG. 1 is a system diagram of the high level architecture of an exemplary system implementing the tag management system;

FIG. 2 is an example flow diagram of the process that runs the global ad tag within a HyperText Markup Language (HTML) document;

FIG. 3 is an example flow diagram of the process that identifies the location that an ad script should be loaded within an HTML document;

FIG. 4 is an example flow diagram of the process that tracks user clicks on ad widgets loaded by the global ad tag;

FIG. 5 is an example flow diagram of the process that optimizes and determines the best combination of advertisements for a publisher's webpage;

FIG. 6 is a diagram of an exemplary webpage showing different standard layouts of recommended advertising widgets;

FIG. 7 is an example flow diagram of the process that loads the global ad tag and corresponding placement tags within an HTML document;

FIG. 8 is an example flow diagram of the process by which the placement tags load and render third party ad partners' content on a webpage;

FIG. 9 is an example flow diagram of the process that identifies the location that an ad script should be loaded within an HTML document using a JavaScript wrapper provided by the tag management system; and

FIG. 10 is an example flow diagram of the process by which clicks are validated.

### DETAILED DESCRIPTION

Certain terminology is used in the following description for convenience only and is not limiting. The terms “a” and “one” are defined as including one or more of the referenced item unless specifically noted otherwise. A reference to a list of items that are cited as “at least one of a, b, or c” (where a, b, and c represent the items being listed) means any single one of the items a, b, or c, or combinations thereof. The terminology includes the words specifically noted above, derivatives thereof, and words of similar import. It is to be understood that the figures and descriptions of the present application have been simplified to illustrate elements that are relevant for a clear understanding of the present methods, systems, and apparatuses, while eliminating, for the purpose of clarity, many other elements found in software and computing systems. One of ordinary skill in the art may recognize that other elements and steps may be desired or required in implementing the present methods, systems, and apparatuses. However, because such elements and steps are well known in the art, a discussion of such elements and steps would not facilitate a better understanding of the present application and thus is not provided herein. The disclosure herein is directed to all such variations and modifications to such elements and elements known to those skilled in the art.

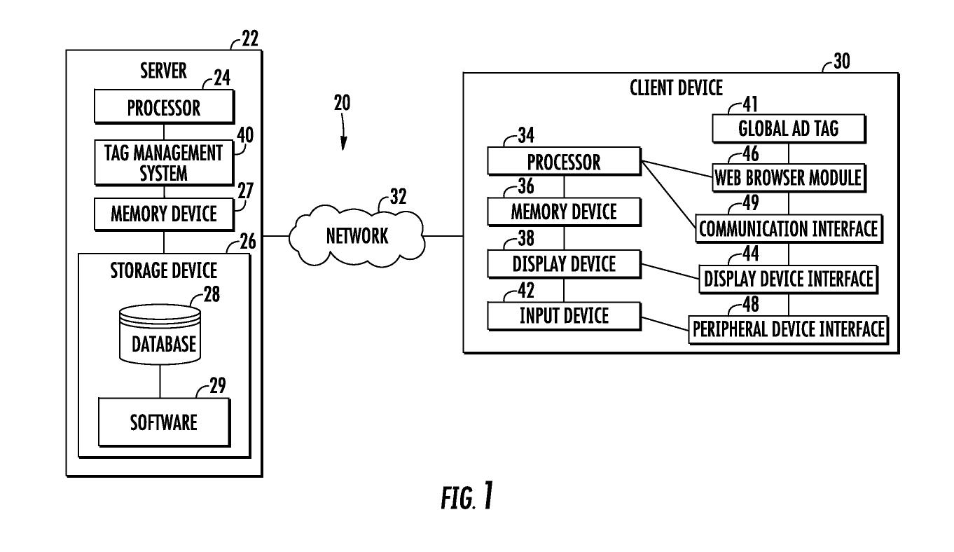

Methods, systems, and apparatuses are described herein for managing and optimizing advertising content placement, rendering third party advertising tags, and tracking analytics associated with third party advertising content. FIG. 1 illustrates an embodiment of an example system 20 that implements the tag management system described herein. The tag management system 40 is a publisher-side platform for various types of advertising content, including native and recommended content advertisements, that enables publishers to manage their utilization of various advertising partners and optimize the placement of those partners' ads. The tag management system 40 may include a dashboard that provides a content management system for a publisher, allowing the publisher to manage the ad selection and placement process via the global ad tag 41 without the need for manually coding or switching out code associated with the specific ads being selected and placed on a webpage.

Currently, internet publishers who wish to monetize their properties by displaying advertisements on those website properties generally form relationships with a number of different advertising partners or networks, including direct advertisers, advertising agencies or exchanges, native and recommended content advertising networks, as well as a variety of other internet advertising providers. In order to display ads from each advertising partner, the publisher is usually provided with a unique script known as an “ad tag” from each partner, which ad tag is then incorporated into the publisher website's HTML or other code. In this manner, when the publisher's website is rendered, the ad tag from that particular advertising partner is also rendered and operates to display an ad to the end user who is viewing the website. The publisher must repeat this process for each advertising partner that it works with, and often needs to include multiple partners' ad tags on a single webpage in order to show different types of ads to a single user. This is a labor intensive process that requires significant developer time and effort and does not allow publishers to easily manage or optimize the different advertising providers utilized on the publisher properties. For example, in order to compare the performance between two different advertising networks on a single webpage, a publisher would need to set up a “split test” by coding the first advertising network's ad tag on one version of the webpage, and then coding the second advertising network's ad tag on a second version of the same webpage, then tracking the data over time and manually comparing the performance between the two networks to determine which network's ads to utilize in order to maximize revenue or other desired metrics. For publishers that utilize multiple advertising networks across various internet properties, this manual process is often unmanageable and even with a dedicated advertising operating team and developer time, does not provide sufficient actionable analytics such as the performance of various advertising networks depending on factors such as the user's location, the type of device or browser used by the user to access the publisher website, the referral sources from where users are sent to the publisher website, along with other variables.

The present system 20 addresses these issues by providing the publisher with a tag management system 40 with a user friendly publisher-facing platform, through which the publisher can easily manage the individual ad tags associated with each advertising network the publisher plans on utilizing on its internet properties. By providing the publisher with one or more global ad tags 41 to be implemented on its internet properties, which then operates in conjunction with the tag management system 40 to selectively choose and render individual ad tags for the selected advertising network to be displayed to each user, as further described below, the present system 20 significantly reduces the level of effort required from the publisher, and allows for more precise and complex targeting and optimization to improve performance of the advertisements displayed on the publisher properties.

As shown in FIG. 1, the system 20 includes a server 22, which may further include a processor 24, a memory device 27, a storage device 26, a database 28, software 29, and the tag management system 40. The server 22 may also be associated with, or incorporated into, any suitable type of computing device, such as, for example and without limitation, a personal computer, a programmable logic controller, or a mobile computing device. The server 22 is in communication with one or more client devices 30, which may be directly associated with the server 22, such as through a direct connection (either wired or wireless) or by being part of the same machine. The server 22 may include a communications port, a wired transceiver, a wired transmitter, a wired receiver, a wireless transceiver, a wireless transmitter, a wireless receiver, or a network card. The server 22 may be capable of communicating using technologies such as Ethernet, fiber optics, microwave, satellite, Public Switched Telephone Network (PTSN), DSL (Digital Subscriber Line), Broadband over Power Lines (BPL), WLAN technology, wireless cellular technology, or any other appropriate technologies.

The server 22 may be implemented using cloud computing technologies. The server 22 may be implemented across various computing, processing, storage, memory, and database devices in the cloud. The server 22 may be accessible via cloud services platforms such as Amazon Web Services, Microsoft Azure, Rackspace, and the like.

The server 22 may further include the tag management system 40, which may be one component of a larger software application on the server 22. The tag management system 40 may reside entirely on the server 22, or may alternatively include certain sub-components that reside on an additional server or computing device, for example as part of software on the additional server or computing device. A user may interact with the tag management system 40 in accordance with any of the embodiments described herein.

The client device 30 may communicate with the server 22 through a network 32 via either a wired or wireless connection, as described in further detail below. The client devices 30 shown in FIG. 1 may be, for example and without limitation, a computing device such as a desktop computer, a laptop computer, a netbook, a tablet computer, a personal digital assistant (PDA), a cellular phone such as a smartphone, or any other appropriate device. The client device 30 may each include a processor 34, a memory device 36, a display device 38, an input device 42, and a web browser module 46 loading the global ad tag 41, which may be in communication with one another and with any other associated components of the client device 30 using any suitable type of communication device, such as a data bus. The client device may further include a communication interface 49, peripheral device interface 48, display device interface 44, which may be coupled to or included within the other components described above, such as the display device 38 and the input device 42.

The memory device 36, 27 in the client device 30 and server 22, respectively, may be or include a device such as a Dynamic Random Access Memory (D-RAM), Static RAM (S-RAM), other RAM, a flash memory, or any other suitable computer-readable medium. The memory device 36 may also be part of or in communication with a storage device of another component in the system 20, such as the storage device 26 of the server 22. The storage device 26 may be or include a hard disk, a solid-state drive (SSD), a magneto-optical medium, an optical medium such as a compact disc-read only memory (CD-ROM), a digital versatile disk (DVD), a Blue-Ray disk (BD), or any other type of computer-readable medium or suitable device for electronic data storage.

The communication interface 49 in the client device 30 may be, for example and without limitation, a communications port, a wired transceiver, a wired transmitter, a wired receiver, a wireless transceiver, a wireless transmitter, a wireless receiver, or a network card. The communication interface 49 may be capable of communicating using technologies such as Ethernet, fiber optics, microwave, satellite, Public Switched Telephone Network (PTSN), DSL (Digital Subscriber Line), Broadband over Power Lines (BPL), WLAN technology, wireless cellular technology, or any other appropriate technologies.

The peripheral device interface 48 in the client device 30 may be configured to communicate with one or more peripheral devices, such as the user input device 42. The peripheral device interface 48 may operate using technologies such as, for example and without limitation, Universal Serial Bus (USB), PS/2, Bluetooth, infrared, serial port, parallel port, or any other appropriate technologies. The peripheral device interface 48 may receive input data from an input device 42 such as a keyboard, mouse, trackball, pointing stick, touch screen, touch pad, stylus pad, or other suitable devices.

The display device interface 44 in the client device 30 may be configured to communicate data to the display device 38. The display device 38 may be, for example and without limitation, a monitor or television display, a plasma display, a liquid crystal display (LCD), or a display based on a technology such as front or rear projection, light emitting diodes (LEDs), organic light-emitting diodes (OLEDS), or Digital Light Processing (DLP). The display device interface 44 may operate using technology such as Video Graphics Array (VGA), Super VGA (S-VGA), Digital Visual Interface (DVI), High-Definition Multimedia Interface (HDMI), or any other appropriate technologies. The display device interface 44 may communicate display data from the processor 34 to the display device 38 to be displayed by the display device 38. The display device 38 may be external to the rest of the client device 30 and coupled to the client device 30 via the display device interface 44. Alternatively, the display device 38 may be included in the client device 30 and may be part of the same component as the input device 42, such as a touch screen display.

The web browser module 46 shown in FIG. 1 may include and/or communicate with one or more sub-modules that perform functionality such as rendering HyperText Markup Language (HTML) (including HTML5), rendering raster and/or vector graphics, executing JavaScript, and/or rendering multimedia content. The web browser module 46 or its sub-modules may also implement technologies such as Rich Internet Application (RIA), Adobe Flash, Microsoft Silverlight, or any other appropriate multimedia technologies. These multimedia technologies may be implemented using one or more web browser plug-in modules and/or by using one or more sub-modules within the web browser module 46 itself.

As discussed above, the storage device 26 of the server 22 shown in FIG. 1 may include a database 28, which may be spread across one or more non-transitory computer-readable mediums, and may be or include one or more relational databases, hierarchical databases, object-oriented databases, one or more flat files, one or more spreadsheets, and/or one or more structured files. The database 28 may be managed by one or more database management systems, which may be based on a technology such as, for example and without limitation, Microsoft SQL Server, MySQL, PostgreSQL, Oracle Relational Database Management System (RDBMS), a NoSQL database technology, or any other appropriate technologies. The database may include a number of different types of data that are used by the server 22, which may be in communication with a client device over a network 32 including but not limited to the Internet, a wireless local area network (WLAN), and/or a cellular network. The database 28 may further be in communication with software 29 of the server 22, which may operate in conjunction with the tag management system 40, or make up a component of the tag management system 40.

An instance of the computing devices, including the exemplary client devices 30 and server 22 shown in FIG. 1, may be configured to perform any feature or any combination of features and methods described herein. Alternatively or additionally, the memory device 36 and/or the storage device 26 of the client device 30 and server 22 respectively may store instructions, which when executed by the processor 24, 34, cause the processor 24, 34 to perform any feature or any combination of features and methods described herein. Furthermore, each or any of the features and methods described herein may be performed by the processor 24, 34 in conjunction with the memory device 36, web browser module 46, communication interface 49, peripheral device interface 48, display device interface 44, and/or storage device 26. Specifically, the server 22 may be used to run the tag management system 40, and the client device 30 may be in communication with the tag management system 40 over the network 32.

As used herein, the term “processor” in reference to the processors 24, 34 of the server 22 and client device 30 broadly refers to any unit, module, or machine capable of executing a sequence of instructions, such as, for example and without limitation, a single-core or multi-core processor, a general purpose processor, a special purpose processor, a conventional processor, a Graphics Processing Unit (GPU), a digital signal processor (DSP), one or a plurality of microprocessors, one or more microprocessors associated with a DSP core, a controller, a microcontroller, one or more Application Specific Integrated Circuits (ASICs), one or more Field Programmable Gate Array (FPGA) circuits, any other type of integrated circuit (ID), a system-on-a-chip (SOC), a Complex Instruction Set Computer (CISC), a Reduced Instruction Set Computer (RISC), or a state machine.

As used herein, the term “non-transitory computer-readable medium” broadly refers to any storage medium that may store or transfer information, including volatile, nonvolatile, removable, and non-removable media. Examples of a computer-readable medium include, but are not limited to, a register, a cache memory, an electronic circuit, a fiber optic medium, a Read Only Memory (ROM), a semiconductor memory device (such as a D-RAM, S-RAM, or other RAM), a magnetic medium (such as a hard disk drive, a tape drive, a magneto-optical medium, or a floppy drive), a flash memory medium (such as a USB flash drive or a flash memory card), a flash based or D-RAM based solid-state drive (SSD), an optical disk (such as CDs, DVDs, or BDs), or any other suitable device for electronic data storage.

Although the methods and features of the present application are described herein as being performed using the example architecture of FIG. 1 the present method and features may be performed, mutatis mutandis, using any appropriate architecture or environment. For example and without limitation, the tag management system 40 features described herein may be implemented using cloud computing technologies. Additionally, the components of the server 22 may be included as part of, or the same components as, those of the client device 30, such that the steps and operations described below as being performed by the server 22 are performed locally on the client device 30 instead. Furthermore, although the web browser module 46 in the client device 30 is described herein as implementing specific web browser technologies, it should be understood that the features described herein as performed by the web browser module 46 may alternatively or additionally be implemented using a specific purpose application, including but not limited to an application that is configured to run on an operating system such as Microsoft Windows, Apple OS X, Unix, Linux, Android, Windows Mobile, Apple iOS, or any other appropriate general purpose or mobile operating system.

The tag management system 40 described herein enables publishers to manage, measure, and maximize advertising revenue related to the advertising tags implemented on (and content displayed on) the publishers' internet properties. The tag management system 40 provides tools, reporting, and analytics that enable a publisher to create rules and optimize decisions related to selecting and displaying advertising content on the publisher's internet properties. For example, the tag management system 40 enables publishers to attribute and measure all inbound traffic sources (i.e., the referral sources or websites through which a user is directed to a webpage on the publisher's website). In the internet industry, many publishers pay to “acquire” or “drive” users/viewers, or “traffic” to the publisher's websites, sometimes through ads displaying a popular article on the website, which may be displayed for example and without limitation on Facebook as a sponsored post, in a recommended content widget as one of the ads, or as a link on another website. In each one of these scenarios, the publisher pays the referral source for each user that clicks on an ad that leads the user to the publisher's website, usually on a cost-per-click (“CPC”) basis. Accordingly, publishers are always attempting to identify the best traffic sources that drive users to the publisher's website at the lowest CPC rates while achieving desirable click-through-rates (“CTR”). The tag management system 40 enables targeting and reporting on data specific to each traffic partner in order to accurately identify high and low value traffic and respond immediately. For example, a publisher may elect to increase its advertising spend budget with a particular traffic partner, or select different ads linking to different content on the publisher's internet properties to display on different traffic sources, based on data analytics tracked by the tag management system 40, including but not limited to the number of clicks on a particular ad on a particular traffic source that leads to the publisher's website. These functions allow a publisher to more efficiently allocate audience acquisition spending.

The tag management system 40 also enables optimization of ad placement and selection. Publishers can manage, test, and optimize each ad provider. As discussed above, the tag management system 40 allows a publisher to set up each individual ad provider and upload the corresponding ad tags in the publisher dashboard of the system 40, while only the global tags 41 are hard coded onto the publisher's website. The tag management system 40 allows the publisher to set up rules governing which ad provider's ad tags, and by extension the corresponding ads, are served through the global tags 41 under what circumstances. For example, the publisher can set up rules selecting a different ad provider to be displayed for the same webpage depending on the type of the client device 30 being used to access that website. The publisher may make this decision based on analytics provided through the tag management system 40, which may show that ad provider A generates more revenues for users using tablet devices, while ad provider B generates more revenues for users using desktop computers, while ad provider C generates more revenues for users using mobile devices. By way of further example, the publisher may set up rules selecting a different ad provider to be displayed on different webpages on the same website, such as on an article by article basis, if the publisher determines that a particular ad provider performs better on specific articles, or that the advertising content displayed by a particular ad provider fits in better with the content and style of specific articles.

In addition to utilizing rules set up by the publisher, the tag management system 40 is also configured to optimize and determine the best combination of advertisements for a publisher's websites through the use of advanced machine-learning algorithms. The machine-learning algorithms may enable a publisher to choose the best recommended-content ad or other type of ad for publishing on their website utilizing a number of different criteria and measurements. The machine-learning algorithms may analyze factors including, but not limited, to ad performance, user location, user device, user agent, and ad viewability in order to then determine the best ad for every single impression. Decisions may be made by the system in real-time, while maximizing quality and ad revenue. This also allows the publisher to maximize the ad revenues generated by its various ad providers on the publisher's internet properties with a minimum amount of effort and administration.

The tag management system 40 consolidates management of ad content from multiple advertising partners using a single global ad tag, or multiple global ad tags, such as a “header” tag, a separate “body” tag, and/or a separate “footer” tag. The global ad tag may be any HTML markup, for example and without limitation, a HTML <script> tag, which executes JavaScript (“JS”) to perform the necessary functions for the tag management system 40. The tag management system may include one or more placement tags, which are placed by the publisher within the website's code in locations where advertising content is to be displayed. The utilization of a global ad tag in conjunction with one or more placement tags allows a publisher to avoid the process of hard-coding different ads tags on their webpage to accommodate the formats of various advertising partners and display different advertising content or widgets of those partners. Instead, once the global ad tag executes the JS code on a client's browser and device, the JS code identifies the placement tag on the publisher's webpage and determines, based on the backend rules set up in the tag management system 40, which specific ad partner's ad tag to request from the tag management system 40 in order to serve that ad partner's ad tag and corresponding advertising content for that specific placement. The global ad tag and placement ad tag are cross-compatible with other ad tags provided by the advertising partners, including loading asynchronous scripts within those tags.

Most publishers include ads within a webpage by placing a snippet of JavaScript code via the HTML <script> tag. These scripts may be loaded synchronously or asynchronously.

When a synchronous script is loaded asynchronously within a webpage, it may cause issues with the page, such as overwriting the entire contents of the page, in cases where the page employs the Document Object Model (DOM) document.write or document.writeln functions. The contents of the page may be overwritten or deleted because as that code appears synchronously, the document.write or document.writeln functions cause the text or code passed to it to be written in the exact position of those functions on the page before loading the rest of the content on the page. Once the page content finishes loading, the HTML document is considered closed, so calling those functions after the HTML document is considered closed would cause the document to be re-opened effectively clearing it and starting fresh.

HTML <iframe> tags define a location on an HTML document in which a separate HTML document may be displayed. One method for addressing the issue described above with respect to loading the document.write or document.writeln functions asynchronously is by dynamically creating iframes using the HTML <iframe> tags and including those functions inside the iframe. Because an iframe is considered a separate HTML document, loading the document.write or document.writeln functions asynchronously would not have any adverse effects on the existing page. As a result, most publishers render ads within a webpage by using iframe tags, which essentially renders their advertising material within a separate inline frame to be displayed within the HTML document of the webpage.

However, this use of iframes brings the ad code outside of the current page context, making management of dynamically sized units and access to variables more challenging and inefficient. As a result, the webpage publisher has very limited access to analytics associated with the ad or control of the content or placement of the ad. Also, the use of iframes does not provide a transparent way for ad tags to be placed asynchronously on the page.

However, the global ad tag and placement tags of the present tag management system 40 have the capability to load asynchronous scripts within a webpage without the use of iframes. One benefit of loading code asynchronously is that it does not block the page from rendering, so data may be loaded effectively on the page while the asynchronous piece of code loads in the background.

Because the code is loading asynchronously, other scripts on the page will want to access data that would have been set by synchronous code, but is not present at the particular load time of those scripts. One way that the tag management system 40 solves this issue includes overwriting the browser defined document.write function and document.writeln functions with wrapper functions provided by the global ad tag of tag management system 40, which for example may be a JavaScript wrapper function. The wrapper functions provided by the global ad tag of the tag management system 40 may overwrite the document.write function or document.writeln function after identifying the location on the HTML document of the script that called the document.write function or document.writeln function, and performing the overwrite at that specific location, which is described in more detail below.

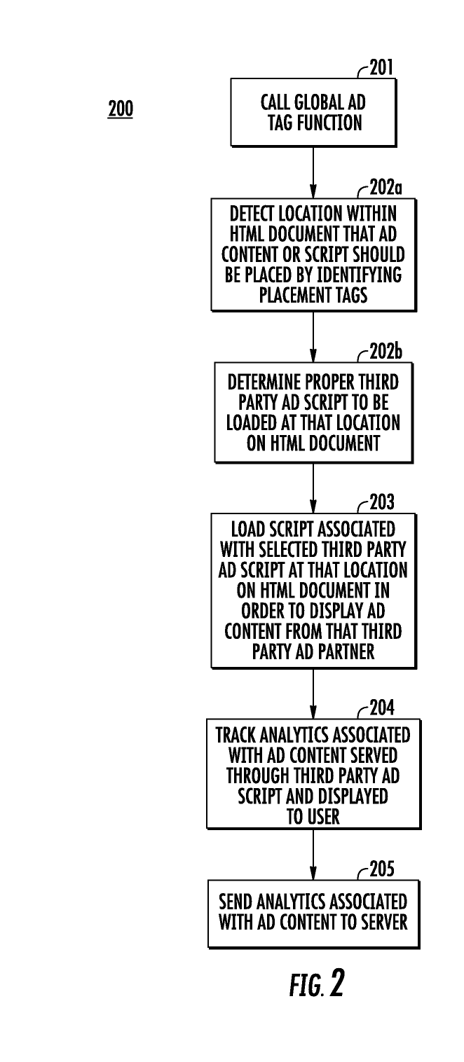

FIG. 2 is an example flow diagram of the process that runs the global ad tag and corresponding placement tags within an HTML document 200, which may be performed by a client device 30 in accordance with one example embodiment, which may be used in combination with any of the embodiments described herein. When the function within the global ad tag is called 201, the function may detect the location within the HTML document that the ad content or script should be placed 202a. For example and without limitation, the detection may be achieved through the function within the global ad tag 201 detecting one or more placement tags that are placed within the HTML document 200, the positions of the placement tags being selected to correspond to where on the webpage the publisher wishes to display advertising content from its third party ad partners. After detecting the location for the ad placement, such as by identifying the placement tag, the function may determine the proper third party script to be loaded at that location on the HTML document 202b in order to render the ad content associated with that third party script (i.e. third party ad partner) on the webpage in that location. The function 202b may make this determination by, for example and without limitation, communicating with the tag management system 40 and/or the associated backend server 22 on which the tag management system 40 is hosted to access the logic for selecting the proper third party ad partner's script to be utilized at that particular location, for that particular webpage, and for that particular user who is viewing the webpage. The logic may be dictated by the rules the publisher set up through its dashboard of the tag management system 40, such as rules that specify which ad partner's script to load for different webpages on the publisher's internet properties, for users located in different geographies (as determined by the user's IP address), depending on the time of day, depending on the type of client device 30 the user is accessing the webpage through, etc. In addition to or as an alternative to the publisher's established rules, the logic accessed by function 202b may be based on rules and machine-learning algorithms incorporated within the tag management system 40, which is configured to optimize and determine the best utilization and combination of ad partners for the publisher's webpages based on various criteria and measurements.

After the function 202b determines the proper third party script to be loaded at the location on the HTML document, the global ad tag function 201 in conjunction with the placement tags may then load the script associated with the selected third party ad script at that location on the HTML document 203 in order to display ad content from that third party ad partner. The global ad tag may then track analytics associated with the ad content served through the third party ad script and displayed to the user 204, including but not limited to performance, location, type of user or computing device, user agent, ad viewability, the number of clicks on the ad, and the click-through-rate (“CTR”) for that ad or ad partner. These analytics may then be sent to the tag management system 205 located within a publisher's content management system running on the server 22 or other computing device. The analytics data may be utilized by the tag management system 40 to be displayed in the publisher's dashboard, in reports provided to the publisher, or as part of the system's machine-learning algorithms and other data analysis to improve performance.

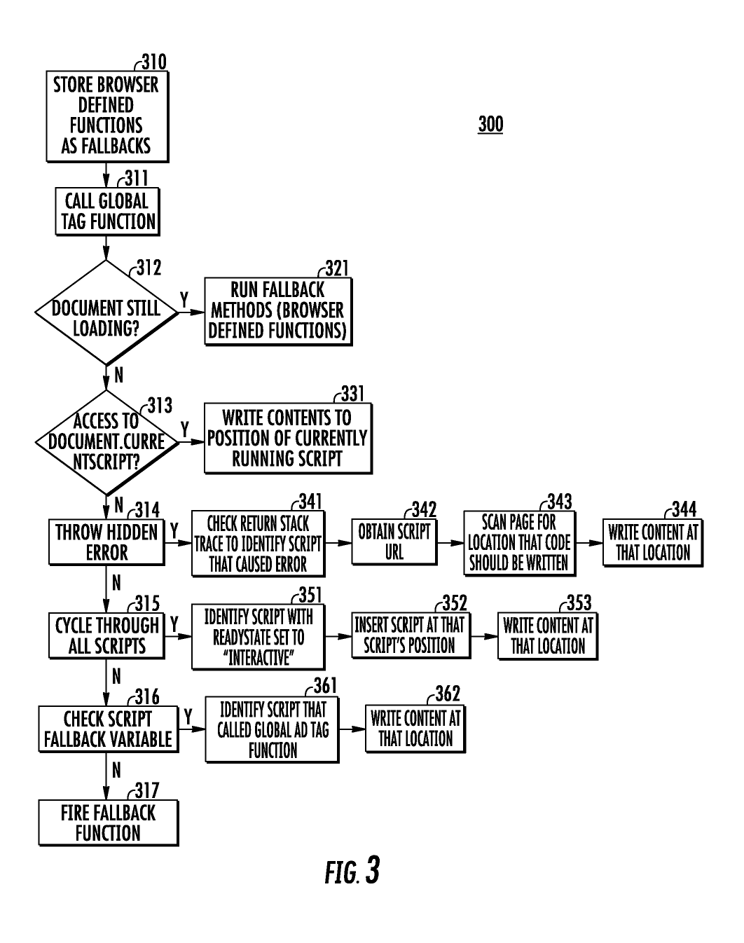

FIG. 3 is an example flow diagram of the process that identifies the location that an ad script should be asynchronously loaded within an HTML document 300 in accordance with one example embodiment, which may be used in combination with any of the embodiments described herein, including the simplified server 22 and client device 30 shown in FIG. 1. When overwriting the browser defined document.write and document.writeln functions using for example a JavaScript wrapper provided by the global ad tag, copies of those browser defined functions may be stored as fallbacks 310. Once the function within the global ad tag is called 311, a check may be performed to determine whether the HTML document is still loading 312. If the document is still loading, a fallback method (document.write function or document.writeln function) may be run 321 because the document has not closed yet and therefore it is safe to run the fallback method.

Otherwise, a check is performed to determine whether there is access to the document.currentScript object 313, which identifies the script that is currently running. The document.currentScript object is available in most modern browsers. If there is access to document.currentScript object, the global ad tag content may be written out to or rendered at the location of the script on the page identified by document.currentScript as the currently running script 331, which simulates where that content would have been written had it been loaded synchronously.

If there is no access to the document.currentScript object, a hidden error may be thrown on the page 314. Once the global ad tag code has executed throwing the hidden error, a check may then be performed on the returned stack trace to identify which script caused the error 341. This method may provide a script uniform resource locator (URL) 342. The global ad tag code may then scan the page to find the position where the code should be written 343, and then the content is written out to or rendered at that position 344. If this method is not available, all the scripts on the page may be cycled through 315 to identify a script that has a readyState set to “interactive” 351, which may mean that this script is the one currently executing. The code may then be inserted at that script's position 352, and that position may then be used to write the global ad tag code 353.

In the event that is not available, a script fallback variable may be checked 316. This script fallback variable is set at a time before calling the global ad tag function (and is unset right after). Checking the script fallback variable 316 may identify which script on the page potentially called the global ad tag function 361. That position may then be used to write or render the global ad tag code 362.

If these methods are not successful, the global ad tag function may fire the fallback function 317.

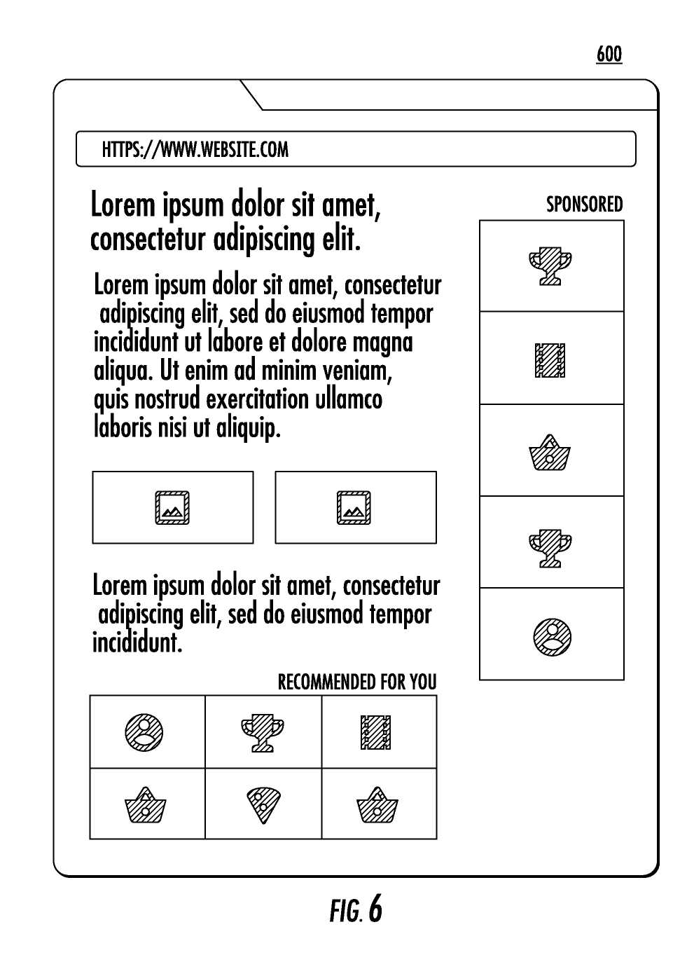

As described above, the tag management system 40 may track various analytics associated with the ad content rendered via the global ad tag and placement tag described above. For example, clicks on a third party ad partner's advertising widget, which is rendered as a result of that ad partners' ad script being selected and served through the global ad tag and placement tag, may be tracked in accordance with one embodiment. The global ad tag may track when and where a click occurs on an ad widget and may track different spots on the widget to determine exactly where the user clicked. An exemplary advertising widget is illustrated in FIG. 6, which shows a standard layout of a recommended advertising widget 600 in which ads are displayed in a 2×3 format with two rows of three ads each, as well as another layout of a recommended advertising widget where a single column of ads are shown on the right hand side of the content on the webpage. Depending on which ad attracted the user's interest, the user would click on a different location within the widget in order to go to the article being promoted by that tag. There is no current way for a publisher to know which specific ad a user is clicking on an advertising widget, which can provide useful insight into user behavior and reoccurring trends, such as which location for an ad a user is most likely to click on a side advertising widget. The tag management system 40 may track user interaction with ad widgets based on handlers on the widget. These handlers provide the tag management system information including but not limited to which ad unit on the widget was clicked and an approximate location of the click.

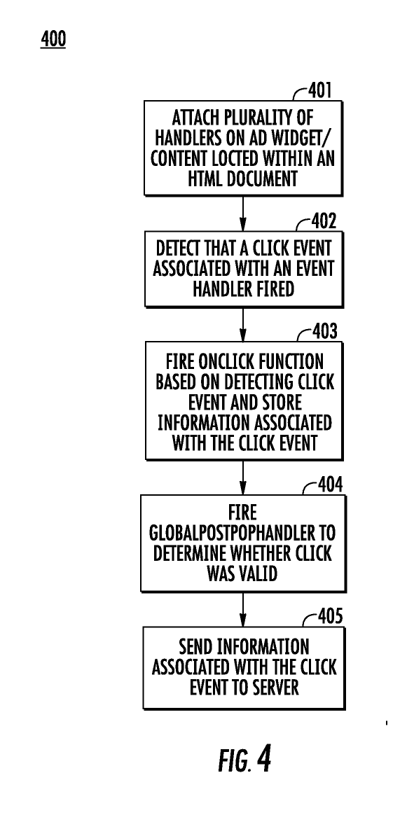

FIG. 4 is an example flow diagram of the process that tracks information relating to user clicks on ad widgets loaded by the global ad tag in conjunction with one or more placement tags 400 in accordance with one example embodiment, which may be used in combination with any of the embodiments described herein, including the server 22 and client device 30 shown in FIG. 1. When the global ad tag code initially loads, handlers may be attached on the third party ad script that renders the ad widget 401 within the content of the global ad tag on the following:

(1) The window object for multiple events, including but not limited to the following: mousedown, click, mousemove, touchmove, touchstart, pointerdown, and mspointerdown. When any of these events fire, the location of the event (i.e. click location) on the page may be temporarily stored.

(2) The window object for multiple events, including but not limited to the following: beforeunload, pagehide, and unload. When any of these events fire, the GlobalPostPopHandler function as defined below is run.

Handlers may also be attached based on the web browser version used. For example, in versions Internet Explorer less than version 10, GlobalPostPopHandler is attached to the focusout event.

When more modern web browsers are used and there is access to the Page Visibility API in the HTML5 standard, then an event handler may be attached on the document object for events including but not limited to: webkitvisibilitychange, mozvisibilitychange, msvisibilitychange, and visibilitychange. Attaching handlers for these events may determine whether the page is currently marked by the Visibility API as hidden. If the page is marked as hidden, the GlobalPostPopHandler function runs.

An event handler may be attached on the window object for a blur event. This event handler may have different behavior based on whether the user is currently on a desktop browser or mobile browser. If the code detects that the user is on a desktop browser, the code may determine whether the page is currently marked by the Visibility API as hidden. If the page is marked as hidden, the GlobalPostPopHandler function runs.

If the global ad tag code detects that the user is on a mobile browser, several checks may be performed to account for discrepancies. First, a check will be performed to determine whether the last click in any of the widgets that were placed by the global tag was to an HTML element that is an A element (anchor) or to an HTML element that has a parent that is an A element. If either the click was to an HTML element that is an A element (anchor) or to an HTML element that has a parent that is an A element, the GlobalPostPopHandler function runs.

If the click was not to an HTML element that is an A element (anchor) or to an HTML element that has a parent that is an A element, the global ad tag code may determine whether the page is currently marked by the Visibility API as hidden. If the page is marked as hidden, the GlobalPostPopHandler function runs.

If the page is not marked as hidden, a check will be performed on document activeElement, which identifies the element on the page that currently has focus. If the element that currently has focus is an element that resides inside of one of the widget containers, the GlobalPostPopHandler function runs.

For older browsers where there may be no access to the Page Visibility API, then a handler is attached for the blur event to the window object which will run the GlobalPostPopHandler function when it fires.

When the ad script for the ad widget loads the publisher-defined code, such as ad tags or other code provided to the publisher by its third-party ad partner, the global ad tag code continually scans, either by using a MutationObserver (when available), or on a set interval, for new elements being created inside of the widget container. Once the code detects new elements that fit criteria as defined herein, multiple handlers may be attached on those elements. For example, an event handler for mousedown and click events may be attached. When global ad tag code detects that any of these events fired 402 (i.e. the user has most likely clicked on the element), the onClick function as defined below is fired 403.

When the onClick function is run, a global variable is set that may store the following: the context of the detected click event (e.g. identity/name/type of widget on the page that was clicked as well as other important information about it), the mouse position on the page, the element we attached the handler to, the current timestamp, the event type (e.g. whether mousedown or click), whether or not the event target (e.g. the element the event refers to) is an Anchor tag (A) or has a parent who is an Anchor tag, and an eligibility flag of “true.”

A timer is also set that expires after 1 second, which will set the global variable eligibility flag to false if there was a last recorded click in a widget and that click was to the current context and matched the current timestamp (to not double count clicks).

Running the GlobalPostPopHandler function may determine whether the click was valid 404. If the current event type was a “click”, logic runs the GlobalPostPopHandler function, the element was an Anchor tag or has an Anchor parent, and the code detects that the user when clicking either middle clicked, right clicked, or held down the shift, control, or meta key. When these types of clicks are detected, most browsers would then open the link in a new tab without losing focus to the current page, so the global event handlers which check for the page becoming hidden cannot be relied on accurately.

The global variable as defined above with respect to the onClick function may be checked to determine whether the event type is a “click,” the target is an Anchor tag (A) or has a parent that is an Anchor tag, has an eligibility flag of false, the current event type (of GlobalPostPopHandler) is pagehide or unload, and the beforeunload event has fired in the past (signifying the page is navigating away). If these conditions are met, the global variable eligibility flag is re-marked to “true.”

If the global variable is not set, or if the global variable eligibility flag is set to “false,” the document's activeElement (element in focus) is checked to see if the element is inside of any of the dropped widgets. If so, a simulated last recorded click to this element is set and the eligibility flag is set to “true.” If the global variable is still not set or the global variable eligibility flag is still “false”, the function is exited because a reliable click has not been detected.

Otherwise, the click is valid and is recorded. Recorded clicks may then be sent 405 to the tag management system 40 as part of the analytics provided to a publisher. The global variables regarding the click may be un-set so that it is not considered again the next time the GlobalPostPopHandler function runs. The global variables regarding the click may be un-set either before or after the recorded clicks are sent 405 to the tag management system 40.

The global ad tag code may also check another global variable of clicks to ignore, which includes descriptive information of elements and their click position on the page to make sure that the code is not identifying a duplicate click that was already recorded. When the global ad tag code checks this global variable of clicks to ignore, if it does match an element in that list, then the function exits.

For the special case of the document activeElement being a IFRAME, EMBED or OBJECT element, a focus back is forced on the body when the document focusin event fires as an additional measure for not recording duplicate clicks.

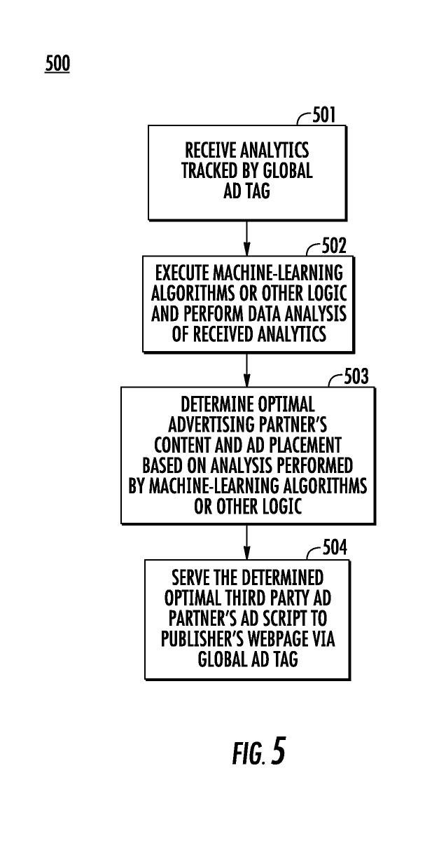

FIG. 5 is an example flow diagram of the process that optimizes and determines the best third party advertising partner to utilize and/or combination of advertising partners and advertisements for a publisher's webpage 500, which may be performed by the server 22, in accordance with one example embodiment, which may be used in combination with any of the embodiments described herein. As described above, the tag management system 40 includes machine-learning algorithms and other logic/rules that analyze the analytics information received from the global ad tag code. Referring to FIG. 5, the tag management system 40 may receive the analytics 501 tracked by the global ad tag in accordance with any of the methods described herein. The machine-learning algorithms or other logic implemented in the tag management system 40 may then execute and perform data analysis of the received analytics 502. Such data analysis may include, for example and without limitation, analysis based on the click-through-rates (CTR), revenues generated, or other metrics associated with each different third party ad partner's advertisements, the CTR, revenues, or other metrics associated with different user devices that is used to view each webpage, the CTR, revenues, or other metrics associated with users located in different geographies, and the CTR, revenues, or other metrics associated with different times of the day. The tag management system 40 may then determine the optimal advertising partner's content and ad placement on the publisher's webpage 503 based on the analysis performed by the executed machine-learning algorithm or other logic. The tag management system 40 may then serve the determined third party ad partner's ad script to the publisher's webpage 504 via the global ad tag and placement tag in accordance with the methods described herein, after which the selected third party ad partner's ad content will be rendered and displayed at that location of the webpage.

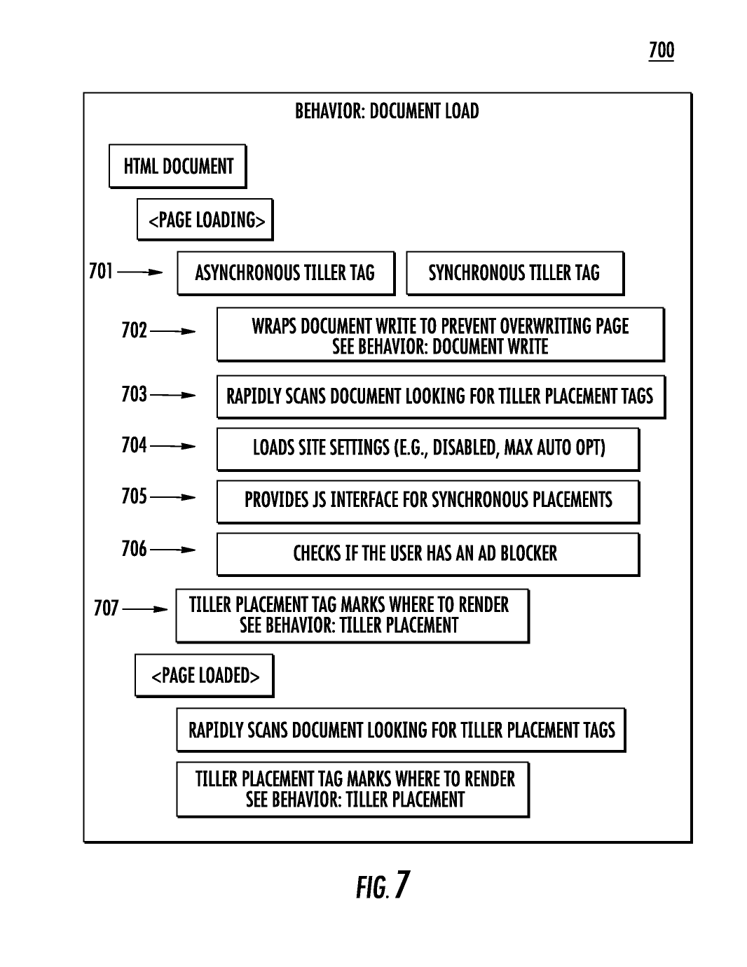

FIG. 7 is an example flow diagram of the process that loads the global ad tag and corresponding placement tags within an HTML document 700, which may be performed in accordance with any of the embodiments described herein. The global tag and placement tags may be loaded either asynchronously or synchronously. After loading either an asynchronous or synchronous global ad tag 701, document.write may be wrapped to prevent overwriting the web page 702. The global ad tag code may then scan the document looking for placement tags 703. Site settings may then be loaded 704, which include internal settings that can be set for each website with rules relating to that specific site. Rules specific to that site include but are not limited to whether to run certain tag placement, what the auto-optimization settings for that site should be, etc. These rules may include rules that the tag management system 40 or the publisher sets for that particular website. The global tag and placement tag code may then provide the JS interface for synchronous placements of tags 705 and may then check whether the user has an ad blocker activated on that site 706, which allows detection of “adblocked” users and makes decisions on which third party ad partners' tags to use and/or provide that information to the publisher and in the analytics. The placement tag code may then mark the location on the page to render code and serve the third party ad partner's ad script and content 707, which is described in more detail below.

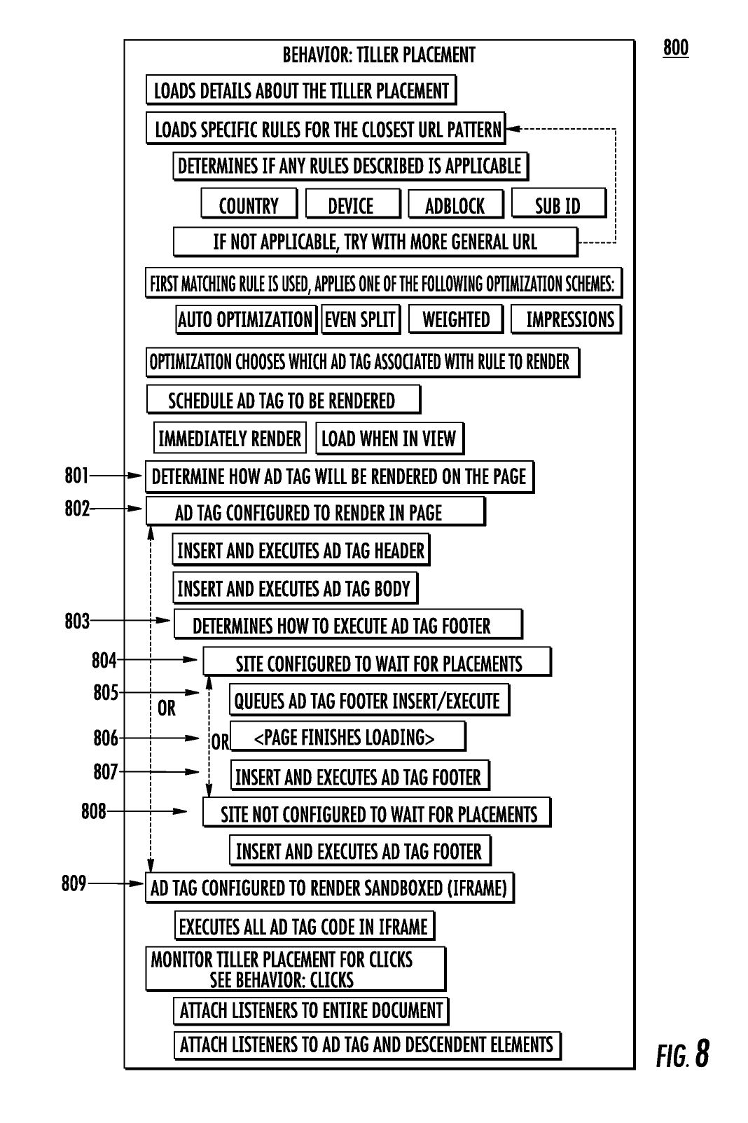

FIG. 8 is an example flow diagram of the process by which the placement tags load and render third party ad partners' content on a webpage 800, which may be performed in accordance with any of the embodiments described herein. The placement tags may load and render third party ad partners' content on a webpage with or without the use of an iframe. The placement tag code determines how the global ad tag will be rendered on the page 801. Once this determination has been made, the placement tag code may determine that the global ad tag is configured to render in page (in-line HTML) 802 in order to render a third party ad tag without the use of an iframe. The placement tag code may then determine how to execute the global ad tag footer 803. In making this determination, the placement tag code may determine when to load that footer ad tag placement on a site by site or webpage by webpage basis and based on which third party ad partner's content is being loaded and other variables. If the site is configured to wait for placements as determined by the placement tag code or as a rule within the system 804, the footer code is queued up 805. The placement tag code then may then wait until the page finishes loading 806, before then inserting and executing that footer code and rendering the corresponding content 807. Alternatively, if the site is not configured to wait for placements 808, then the placement tag code immediately inserts and executes the global ad tag footer to render that content.

Alternatively, the placement tag code may determine that the global ad tag is configured to render sandboxed (iframe) 809 in order to render a third party ad tag using an iframe.

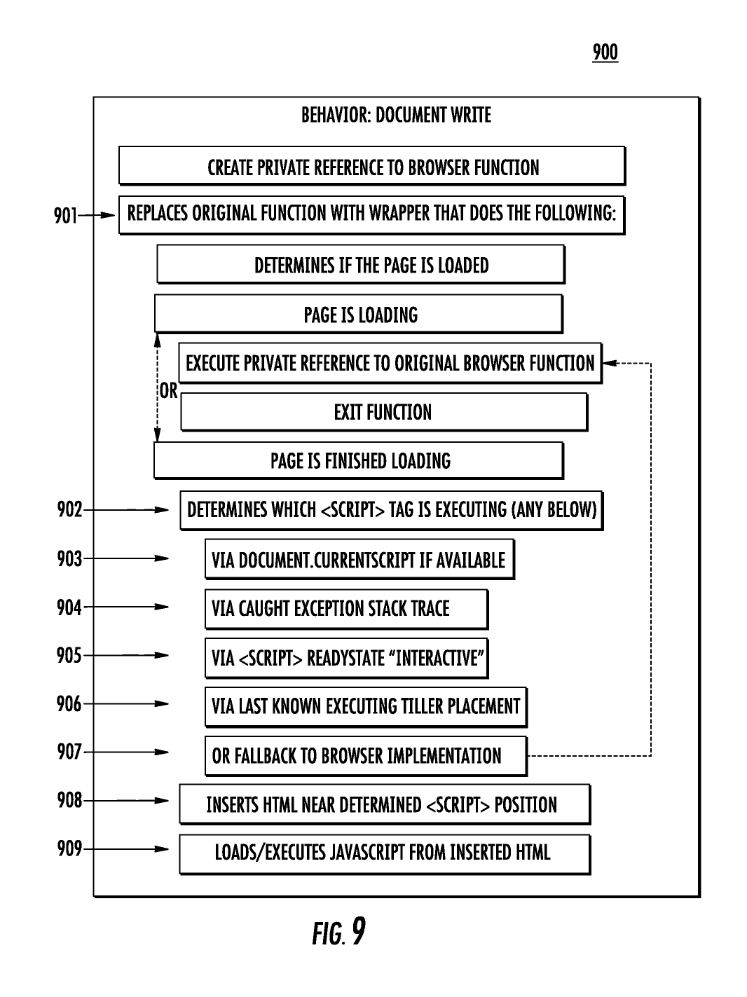

FIG. 9 is an example flow diagram of the process 900 that identifies the location that an ad script should be loaded within an HTML document using a JavaScript wrapper provided by the tag management system 40, which may be performed in accordance with any of the embodiments described herein. The tag management system 40 looks at the HTML document to determine where an original document.write function is actually executed on the page and which script executed to call the document.write function and then inserts code at that location of the page (or as close as possible) in order to do a script tag replacement so that the scripts may be executed in the correct order. As described herein, this avoids the page being cleared or triggering a browser warning.

The tag management system 40 executes asynchronously allowing the rest of the page to load while requesting its own resources. Some third party advertisers' code is written with the expectation of being executed within the page as the page loads. Because tag management system 40 may execute asynchronously as described above (allowing the rest of the page to continue loading while the tag management system 40 code loads), this expectation is broken as it is not guaranteed when the tag management system 40 will insert a given advertisement into its respective placement. The given advertisement may be loaded as the page is loading that point of the document or still loading the page.

As described above, this presents a problem: document.write and document.writeln inserts and executes HTML immediately after the script tag that invoked it. Further, invoking document.write/document.writeln after the document has loaded will result in a new document being created (or specifically, replacing the entire contents of the page with what was originally supposed to be inserted into the document). One approach to resolve this problem is to overwrite the document.write function to insert the html at a specific point on the page. Commonly this is either as simple as appending HTML to the body element of the page (the document) or to a specific element deemed safe which to insert HTML. However, this approach may not insert the HTML at the expected location in the document. Further, appending HTML (via innerHTML property) does not execute script tags that are present in the code due to security. The methods described herein and enabled by the tag management system 40 resolve these issues.

While the page is loading the tag management system 40 allows the browser default behavior for document.write to occur. However, document.write calls that occur after the document has finished loading are managed by the tag management system 40 via a JavaScript wrapper function that replaces the original document.write function 901. When document.write is called after the document has finished loading, the tag management system 40 determines the location of where the document.write call originated 902. This determination may be made using various methods. Most modern browsers support document.currentScript, which refers to the currently executing script tag. The tag management system 40 may determine which script is executing the document.write function and its location via the document.currentScript function 903. Many browsers that do not support document.currentScript provide stack traces for exceptions. In that case, the tag management system 40 may throw an exception and immediately catch it in order to inspect the stack trace to get the originating URL 904. If the URL is present, the tag management system 40 may look for a script tag that has the same URL to determine which script is executing the document.write function and its location. Another method is for the tag management system 40 to determine whether the executing script tag has a readyState property set to “interactive” 905 in order to determine which script is executing the document.write function and its location. In yet another method, there is a variable that contains a reference to the last inserted JavaScript tag from the tag management system 40 HTML renderer 906, which may be used in order to determine which script is executing the document.write function and its location. In yet another method, the browser implementation may be used as a fallback 907.

Once the tag management system 40 determines which script is currently executing the document.write function and its location, the HTML is rendered on the page after the determined script 908, which may be achieved by placing the tag management system 40 code after the script that called document.write at the location at which it was invoked. The tag management system 40 may render the html by the innerHTML method that prevents script tags from executing. Each script tag may be re-created using DOM methods with the same properties as the original tags and replace the inserted script tags. When the tag is replaced, the browser may execute the script 909.

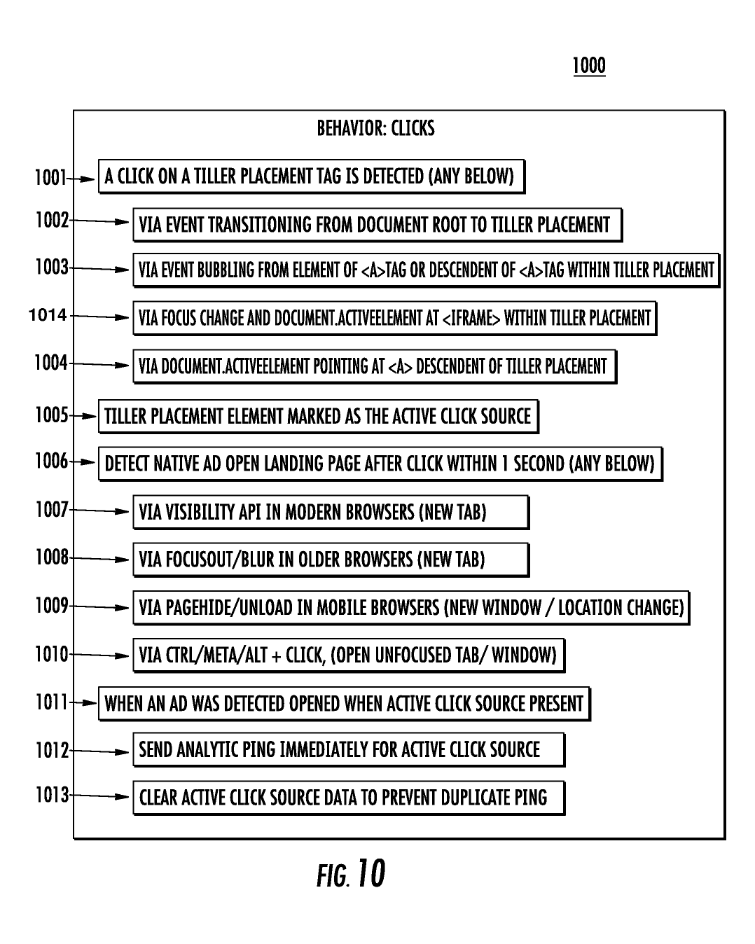

FIG. 10 is an example flow diagram of the process by which clicks are validated 1000, which may be performed in accordance with any of the embodiments described herein. A click may be detected on a placement tag (i.e., whether a click actually occurred on an ad widget rendered by the global ad tag) 1001. This detection may be performed using methods including but not limited to: via event transitioning from document root to placement tag 1002, via event bubbling from element of <a> tag or descendant of <a> tag within the placement tag 1003, via focus change and document.activeElement at <iframe> within the placemen tag 1014, or via document.activeElement pointing at <a> descendent of the placement tag 1004. The placement tag may then mark that placement element as the active click source 1005. The click may then be determined as being valid by using any of the methods described herein and including but not limited to the following: detecting a native ad open landing page after a click within one second 1006 via the visibility API in modern browsers (new tab) 1007, via focusout/blur in older browsers (new tab) 1008, via pagehide/unload in mobile browsers (new window/location change) 1009, or via ctrl/meta/alt+click (open unfocused tab/window) 1010. When an ad was detected opened when an active click source was present and after a determination is made that the click is valid 1011, an analytics ping may be sent 1012 and then the active click source data may be cleared 1013.

Having thus described various embodiments of the present system 20 and tag management system 40 in detail, it is to be appreciated and will be apparent to those skilled in the art that many physical changes, only a few of which are exemplified in the detailed description above, may be made in the methods and apparatuses described herein without altering the inventive concepts and principles embodied herein. The present embodiments are therefore to be considered in all respects as illustrative and not restrictive, the scope of the invention being indicated by the appended claims rather than by the foregoing description, and all changes which come within the meaning and range of equivalency of the claims are therefore to be embraced therein.

Although features and elements are described above in particular combinations, it is to be appreciated that each feature or element can be used alone or in any combination with or without the other features and elements. Any single embodiment described herein may be supplemented with one or more elements from any one or more of the other embodiments described herein. Any single element of an embodiment may be replaced with one or more elements from any one or more of the other embodiments described herein. For example, each feature or element as described herein with reference to any one of FIGS. 1-10 may be used alone without the other features and elements or in various combinations with or without other features and elements from each or any combinations of the other figures from FIGS. 1-10. Each or any combination of features described herein with reference to FIGS. 1-10 may be considered optional. Sub-elements of the methods and features described herein with reference to FIGS. 1-10 may be performed in any arbitrary order (including concurrently) in any combination or sub-combination.

What is claimed is:

1. A method for use in a computing device, the method comprising:
detecting, by a processor, a location within a HyperText Markup Language (HTML) document, wherein the location is associated with placement of advertising content to be rendered via a web browser;
determining, by the processor, a script associated with advertising content to be loaded;
loading, by the processor, the determined script associated with the advertising content at that location on the HTML document;
tracking, by the processor, analytics associated with the advertising content; and
sending, by a communication interface, the analytics associated with the advertising content to a server.

2. The method of claim 1, wherein the analytics are associated with a number of clicks on the advertising content.

3. The method of claim 1, wherein the analytics are associated with a type of device associated with the computing device.

4. The method of claim 1, wherein the analytics are associated with a location associated with the computing device.

5. The method of claim 1, wherein the analytics are associated with a blur event on the computing device.

6. The method of claim 1, further comprising:
attaching, by a processor, a plurality of event handlers on an ad widget located within a HyperText Markup Language (HTML) document;
detecting, by the processor, that a click event associated with an event handler of the plurality of event handlers has fired;
firing, by the processor, a function based on the detected click event to store information associated with the click event; and
sending, by a communication interface, the information associated with the click event to a server.

7. The method of claim 6, wherein the information associated with the click event includes a context of the click, wherein the context includes an identity of ad widget.

8. The method of claim 6, wherein the information associated with the click event includes a mouse position on the HTML document.

9. The method of claim 6, wherein the information associated with the click event includes an element to which the event handler of the plurality of event handlers was attached.

10. The method of claim 6, wherein the information associated with the click event includes a timestamp.

11. A computing device comprising:
a processor configured to detect a location within a HyperText Markup Language (HTML), wherein the location is associated with placement of advertising content to be rendered via a web browser;
the processor further configured to determine a script associated with advertising content to be loaded;
the processor further configured to load the determined script associated with the advertising content at that location on the HTML document;
the processor further configured to track analytics associated with the advertising content; and
a communication interface configured to send the analytics associated with the advertising content to a server.

12. The computing device of claim 11, wherein the analytics are associated with a number of clicks on the advertising content.

13. The computing device of claim 11, wherein the analytics are associated with a type of device associated with the computing device.

14. The computing device of claim 11, wherein the analytics are associated with a location associated with the computing device.

15. The computing device of claim 11, wherein the analytics are associated with a blur event on the computing device.

16. A method for use in a computing device, the method comprising:
detecting, by a processor, whether a HyperText Markup Language (HTML) document is loading;
on a condition that the HTML document is loading, executing, by the processor, a web browser defined function to render advertising content on the HTML document via the web browser;
on a condition that the HTML document is not loading, executing, by the processor, a function to determine which script is currently running on the HTML document; and
rendering, by the processor, advertising content at a location on the HTML document associated with the currently running script.

17. The method of claim 16, further comprising:
on a condition that the script that is currently running on the HTML document cannot be determined, executing, by the processor, a hidden error;
performing, by the processor, a check on a returned stack trace to identify a script that caused the hidden error; and
rendering, by the processor, advertising content at a location on the HTML document associated with the script that caused the hidden error.

18. The method of claim 16, further comprising:
scanning, by the processor, through all scripts associated with the HTML document to determine a script that is currently running on the HTML document; and
rendering, by the processor, advertising content at a location on the HTML document associated with the currently running.

19. The method of claim 16, wherein the web browser defined function is document.write.

20. The method of claim 16, wherein the web browser defined function is document.writeln.
